(19) United States
(12) Patent Application Publication
(10) Pub. No.: US 2014/0331242 A1
(43) Pub. Date: Nov. 6, 2014

(54) MANAGEMENT OF USER MEDIA IMPRESSIONS

(71) Applicant: MICROSOFT CORPORATION, REDMOND, WA (US)

(72) Inventors: ENRIQUE DE LA GARZA, SAMMAMISH, WA (US); KARIN ZILBERSTEIN, KIRKLAND, WA (US); CAROLYN J. FUSON, BELLEVUE, WA (US); MICHAEL PATRICK MOTT, SAMMAMISH, WA (US); ANDREW C. FLAVELL, MEDINA, WA (US)

(73) Assignee: MICROSOFT CORPORATION, REDMOND, WA (US)

(21) Appl. No.: 13/874,932

(22) Filed: May 1, 2013

(51) Int. Cl. H04N 21/442

(52) U.S. Cl. CPC H04N 21/44218
USPC 725/12

(57) ABSTRACT

Systems, methods, and computer-readable storage media are described herein for aggregating viewing data for one or more types of media content. Image data depicting a viewing area of a display device are received. A type of media content being displayed on the display device when the images are captured is identified. Based on the image data, a number of persons may be determined, as well as characteristics about the persons, responses of the persons toward the media content, and levels of engagement of the persons in the media content, or a portion thereof. Each determined item of information may comprise a viewing record for the media content. The viewing records for the media content may then be aggregated to create viewing data for the content, and the viewing data may be distributed to a content provider.

### BACKGROUND

A goal for many media content providers is to collect information about media consumers' likes and dislikes. However, many consumer reports fail to provide information about individual consumers' preferences. As well, such reports may not be as relevant to some providers and types of content as they are for others. Therefore, to improve content providers' knowledge about consumer preferences, new data collection methods are needed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention generally relate to systems, methods and computer-readable media for processing image data to determine a person's reaction toward media content being displayed to the person. As used throughout, media content refers to games, television shows, movies, music, and the like.

Initially, image data is received from an image source that captures images or streaming video of the audience area proximate to a display device. The display device presents media content to persons located within the audience area. The display device may be associated with an entertainment device. Exemplary entertainment devices may include game consoles, media consoles, laptops, tablets, smart phones, televisions, and the like. For example, the display device may be a television set connected to a game or media console.

In one embodiment, media content that is being displayed to the persons within the audience area is identified. The media content may be identified because it is executed on the entertainment device. The content may also be identified using automatic content recognition techniques, as further described below.

Initially, the image data may be processed to detect persons within the audience area. Once detected, the number of persons that are viewing the content may be determined. Additionally, the amount of time each person spends viewing content may also be determined. Characteristics or traits of people within the audience area may similarly be distilled from the image data. For example, a person's gender, identity, and age may be determined.

Upon detecting and/or identifying a person, periodic changes to the person's facial expressions, movements, biometric readings, and the like may be distilled from the image data. These changes may be determined to be responsive or unresponsive to the media content. Similarly, each response may be mapped to a particular portion or segment of the media content being displayed. In this way, a person's response to content may be gleaned from the image data and used to generate viewing records associated with the media content, a category of content (e.g., sports or games), and/or a person.

Upon determining a person's characteristics, responses to, emotions toward and/or levels of viewer engagement in particular media content, the entertainment device may determine that different or targeted media content should be displayed to a person in the audience area. In particular, when media content is determined to be inappropriate, ill-suited or not interesting to a person or a group of persons, the entertainment device may replace the content with different content and distribute the new content for presentation on the entertainment device. In another embodiment, an option to select to change or replace content may be presented to the person on the entertainment device. The decision to automatically alter or provide an option to alter content may be based on a number of determined characteristics or preferences of a person. For example, if a child is in the audience area, a determination may be made to replace explicit content with an animated film. The replacement content may be determined based on, for example, stored preferences of the viewers, real time responses of persons within the audience area, traits of persons within the audience area, default rules, or requests from content providers.

### BRIEF DESCRIPTION OF THE DRAWINGS

Embodiments of the invention are described in detail below with reference to the attached drawing figures, wherein:

FIG. 1 is a block diagram of an exemplary computing environment suitable for implementing embodiments of the invention;

FIG. 2 is a diagram of online entertainment environment, in accordance with an embodiment of the present invention;

FIG. 3 is a diagram of a remote entertainment environment, in accordance with an embodiment of the present invention;

FIG. 4 is a diagram of an exemplary audience area that illustrates presence, in accordance with an embodiment of the present invention;

FIG. 5 is a diagram of an exemplary audience area that illustrates audience member engagement levels, in accordance with an embodiment of the present invention;

FIG. 6 is a diagram of an exemplary audience area that illustrates audience member response to media content, in accordance with an embodiment of the present invention;

FIG. 7 is a flow diagram illustrating an exemplary method of determining a number of viewers that have viewed a type of media content according to an embodiment of the present invention.

FIG. 8 is a flow diagram illustrating an exemplary method of determining a person's level of engagement in a type of media content according to an embodiment of the present invention.

FIG. 9 is a flow diagram illustrating an exemplary method for aggregating and distributing viewing data associated with identified media content according to an embodiment of the present invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide a method for processing image data to determine a person's reaction toward media content being displayed to the person. As used throughout, media content refers to games, television shows, movies, music, and the like.

In one embodiment, a number of persons within the audience area of a display device is determined. Initially, image data depicting the display device's viewing area is received. The image data may be received at an entertainment device that is communicatively coupled to the display device. The content being displayed on the display device may also be received. Based on the image data, the number of persons viewing the content may be determined, generating a viewing record for the content. The viewing record associated with the content may be stored remotely or on an entertainment device, such as a game console.

In another embodiment, a person's responses to content may be distilled from the image data. Exemplary responses include movement, changes to facial features and changes to a person's biometric readings, such as his or her heart rate. Each response may be mapped to an emotion of, a preference of, or a level of engagement in content being displayed on the display device. The responses and associated emotions, preferences, and attention paid to content also may be stored as a viewing record associated with the content.

In another embodiment, upon determining a person's characteristics, responses to, emotions toward and/or levels of viewer engagement in particular media content, the entertainment device may determine that different or targeted media content should be displayed to a person in the audience area. In particular, when media content is determined to be inappropriate, ill-suited or not interesting to a person or a group of persons, the entertainment device may replace the content and distribute new content for presentation on the display device. The decision to alter content may be based on a number of determined characteristics or preferences of a person. For example, if a child is in the audience area, a determination may be made to replace explicit content with an animated film. The subject matter of the replacement content may be determined based on, for example, stored preferences of the viewers, real time responses of persons within the audience area, traits of persons within the audience area, default rules, or requests from content providers. Additionally, a determination is made about whether a type of content can be automatically replaced. For example, secondary content, such as an advertisement or a director's cut, may be automatically replaced. However, primary content, such as a movie or sporting event, may be replaced only after an audience member is prompted with an option to select new content and subsequently makes the selection.

In yet another embodiment, the viewing records for identified types of content or portions of content may be aggregated, generating viewing data for identified content. Aggregation may first occur at the entertainment device. A server may then request and/or receive the aggregated viewing data for identified media content from, for instance, a plurality of entertainment devices. The server may further aggregate the viewing data received from each entertainment device. Additionally, the server may summarize the data according to categories, such as, for example, characteristics of persons viewing the content, average number of persons viewing the content, average amount of time spent watching the content, responses to the content, and the like. After aggregation and/or summarization is complete, the server may communicate the viewing data for one or more types of identified content to content providers or other interested parties.

In one embodiment, a privacy interface is provided. The privacy interface explains how audience data is gathered and used. The audience member is given the opportunity to opt-in or opt-out of all or some uses of the audience data. For example, the audience member may authorize use of explicit audience responses, but opt-out of implicit responses.

As explained in more detail subsequently, audience data and/or viewing records may be abstracted into a persona before sharing with advertisers or otherwise complied. The use of personas maintains the privacy of individual audience members by obscuring personally identifiable information. For example, a viewing record may be recorded as a male, age 25-30, watched commercial YZ and responded positively. The actual viewer is not identified in audience data, even when some information (e.g., age) may be ascertained from a user account that includes personally identified information.

Having briefly described an overview of embodiments of the invention, an exemplary operating environment suitable for use in implementing embodiments of the invention is described below.

### Exemplary Operating Environment

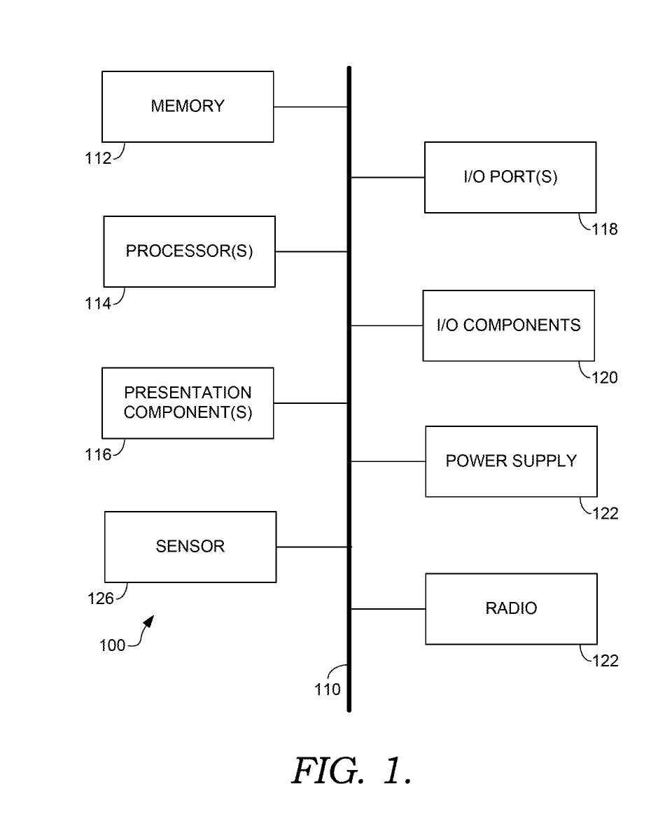

Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Embodiments of the invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120. Also, processors have memory. The inventors hereof recognize that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory 112 may be removable, nonremovable, or a combination thereof. Exemplary memory includes solid-state memory, hard drives, optical-disc drives, etc. Computing device 100 includes one or more processors 114 that read data from various entities such as bus 110, memory 112 or I/O components 120. Presentation component(s) 116 present data indications to a user or other device. Exemplary presentation components 116 include a display device, speaker, printing component, vibrating component, etc. I/I ports 118 allow computing device 100 to be logically coupled to other devices including I/O components 120, some of which may be built in. Illustrative I/O components 120 include a microphone, joystick, game pad, satellite dish, scanner, printer, wireless device, etc.

### Exemplary Entertainment Environment

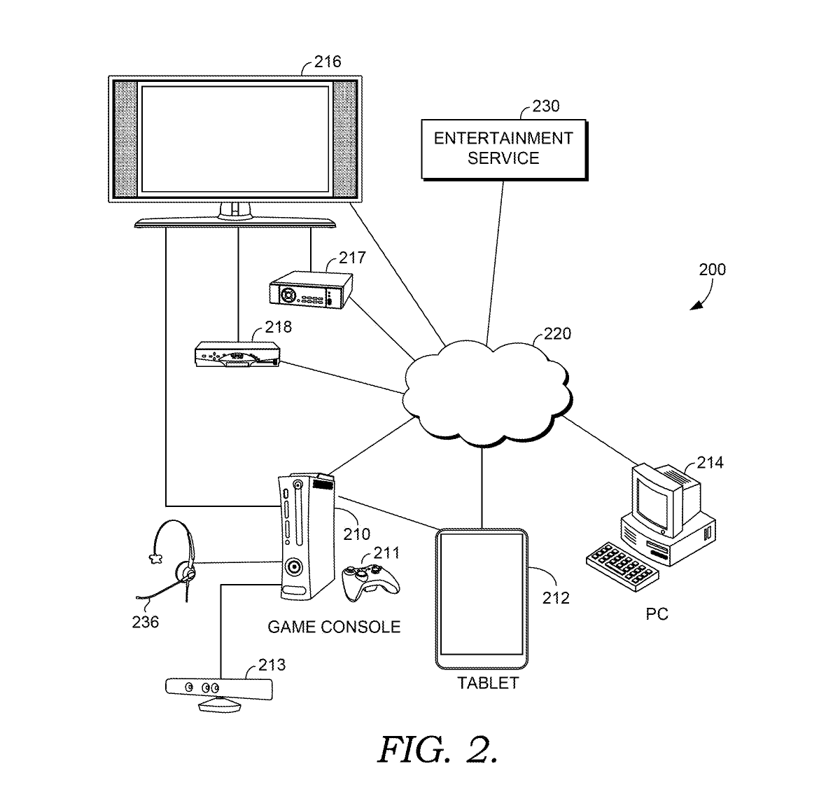

Turning now to FIG. 2, an online entertainment environment 200 is shown, in accordance with an embodiment of the present invention. The online entertainment environment 200 comprises various entertainment devices connected through a network 220 to an entertainment service 230. Exemplary entertainment devices include a game console 210, a tablet 212, a personal computer 214, a digital video recorder 217, a cable box 218, and a television 216. Use of other entertainment devices not depicted in FIG. 2, such as smart phones, is also possible.

The game console 210 may have one or more game controllers communicatively coupled to it. In one embodiment, the tablet 212 may act as an input device for the game console 210 or the personal computer 214. In another embodiment, the tablet 212 is a stand-alone entertainment device. Network 220 may be a wide area network, such as the Internet. As can be seen, most devices shown in FIG. 2 could be directly connected to the network 220. The devices shown in FIG. 2, are able to communicate with each other through the network 220 and/or directly as indicated by the lines connecting the devices.

The controllers associated with game console 210 include a game pad 211, a headset 236, an imaging device 213, and a tablet 212. Tablet 212 is shown coupled directly to the game console 210, but the connection could be indirect through the Internet or a subnet. In one embodiment, the entertainment service 230 helps make a connection between the tablet 212 and the game console 210. The tablet 212 is capable of generating numerous input streams and may also serve as a display output mechanism. In addition to being a primary display, the tablet 212 could provide supplemental information related to primary information shown on a primary display, such as television 216. The input streams generated by the tablet 212 include video and picture data, audio data, movement data, touch screen data, and keyboard input data.

The headset 236 captures audio input from a player and the player's surroundings and may also act as an output device, if it is coupled with a headphone or other speaker.

The imaging device 213 is coupled to game console 210. The imaging device 213 may be a video camera, a still camera, a depth camera, or a video camera capable of taking still or streaming images. In one embodiment, the imaging device 213 includes an infrared light and an infrared camera. The imaging device 213 may also include a microphone, speaker, and other sensors. In one embodiment, the imaging device 213 is a depth camera that generates three-dimensional image data. The three-dimensional image data may be a point cloud or depth cloud. The three-dimensional image data may associate individual pixels with both depth data and color data. For example, a pixel within the depth cloud may include red, green, and blue color data, and X, Y, and Z coordinates. Stereoscopic depth cameras are also possible. The imaging device 213 may have several image gathering components. For example, the imaging device 213 may have multiple cameras. In other embodiments, the imaging device 213 may have multi-directional functionality. In this way, the imaging device 213 may be able to expand or narrow a viewing range or shift its viewing range from side to side and up and down.

The game console 210 may have image processing functionality that is capable of identifying objects within the depth cloud. For example, individual people may be identified along with characteristics of the individual people. In one embodiment, gestures made by the individual people may be distinguished and used to control games or media output by the game console 210. The game console 210 may use the image data, including depth cloud data, for facial recognition purposes to specifically identify individuals within a audience area. The facial recognition function may associate individuals with an account associated with a gaming service or media service, or used for login security purposes, to specifically identify the individual.

In one embodiment, the game console 210 uses microphone, and/or image data captured through imaging device 213 to identify content being displayed through television 216. For example, a microphone may pick up the audio data of a movie being generated by the cable box 218 and displayed on television 216. The audio data may be compared with a database of known audio data and the data identified using automatic content recognition techniques, for example. Content being displayed through the tablet 212 or the PC 214 may be identified in a similar manner. In this way, the game console 210 is able to determine what is presently being displayed to a person regardless of whether the game console 210 is the device generating and/or distributing the content for display.

The game console 210 may include classification programs that analyze image data to generate audience data. For example, the game console 210 may determine how many people are in the audience, audience member characteristics, levels of engagement, and audience response.

In another embodiment, the game console 210 includes a local storage component. The local storage component may store user profiles for individual persons or groups of persons viewing and/or reacting to media content. Each user profile may be stored as a separate file, such as a cookie. The information stored in the user profiles may be updated automatically. Personal information, viewing histories, viewing selections, personal preferences, the number of times a person has viewed known media content, the portions of known media content the person has viewed, a person's responses to known media content, and a person's engagement levels in known media content may be stored in a user profile associated with a person. As described elsewhere, the person may be first identified before information is stored in a user profile associated with the person. In other embodiments, a person's characteristics may be first recognized and mapped to an existing user profile for a person with similar or the same characteristics. Demographic information may also be stored. Each item of information may be stored as a “viewing record” associated with a particular type of media content. As well, viewer personas, as described below, may be stored in a user profile.

Entertainment service 230 may comprise multiple computing devices communicatively coupled to each other. In one embodiment, the entertainment service is implemented using one or more server farms. The server farms may be spread out across various geographic regions including cities throughout the world. In this scenario, the entertainment devices may connect to the closest server farms. Embodiments of the present invention are not limited to this setup. The entertainment service 230 may provide primary content and secondary content. Primary content may include television shows, movies, and video games. Secondary content may include advertisements, social content, directors' information and the like.

FIG. 2 also includes a cable box 218 and a DVR 217. Both of these devices are capable of receiving content through network 220. The content may be on-demand or broadcast as through a cable distribution network. Both the cable box 218 and DVR 217 have a direct connection with television 216. Both devices are capable of outputting content to the television 216 without passing through game console 210. As can be seen, game console 210 also has a direct connection to television 216. Television 216 may be a smart television that is capable of receiving entertainment content directly from entertainment service 230. As mentioned, the game console 210 may perform audio analysis to determine what media title is being output by the television 216 when the title originates with the cable box 218, DVR 217, or television 216.

### Exemplary Advertising and Content Service

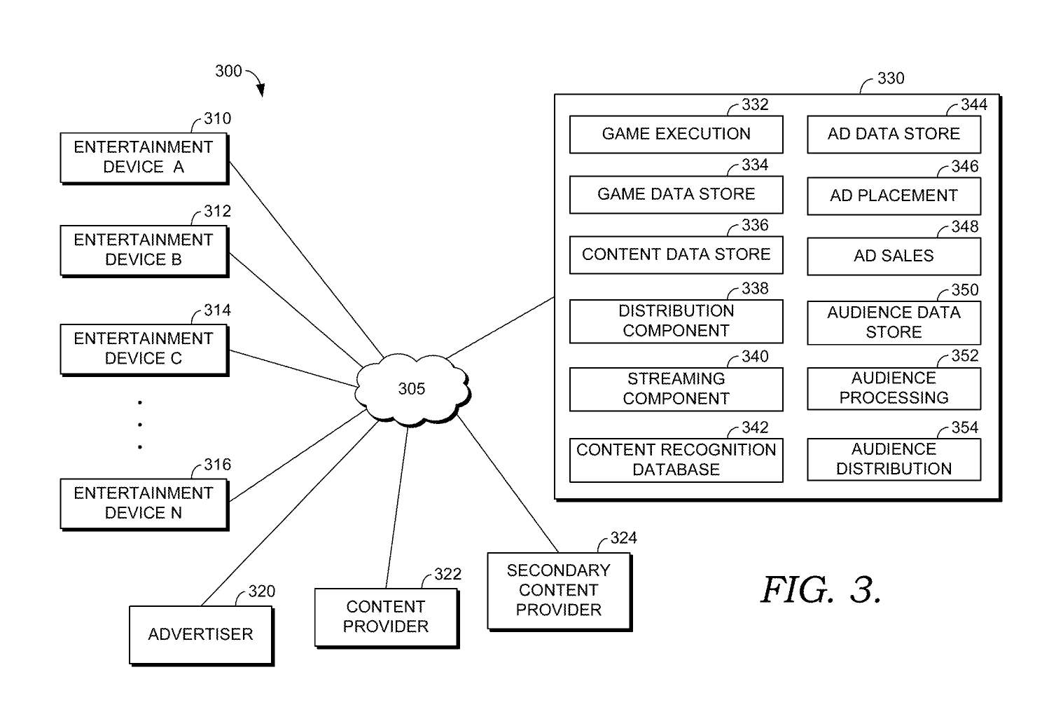

Turning now to FIG. 3, a distributed entertainment environment 300 is shown, in accordance with an embodiment of the present invention. The entertainment environment 300 includes entertainment device A 310, entertainment device B 312, entertainment device C 314, and entertainment device N 316 (hereafter entertainment devices 310-316). Entertainment device N 316 is intended to represent that there could be an almost unlimited number of clients connected to network 305. The entertainment devices 310-316 may take different forms. For example, the entertainment devices 310-316 may be game consoles, televisions, DVRs, cable boxes, personal computers, tablets, or other entertainment devices capable of outputting media. In addition, the entertainment devices 310-316 are capable of gathering viewer data through an imaging device, similar to imaging device 213 of FIG. 2 that was previously described. The imaging device could be built into a client, such as a web cam and microphone, or be a stand-alone device.

In one embodiment, the entertainment devices 310-316 include a local storage component configured to store person profiles for one or more persons. The local storage component is described in greater detail above with reference to the game console 210. The entertainment devices 310-316 may include classification programs that analyze image data to generate audience data. For example, the entertainment devices 310-316 may determine how many people are in the audience, audience member characteristics, levels of engagement, and audience response.

Network 305 is a wide area network, such as the Internet. Network 305 is connected to advertiser 320, content provider 322, and secondary content provider 324. The advertiser 320 distributes advertisements to entertainment devices 310-316. The advertiser 320 may also cooperate with entertainment service 330 to provide advertisements. The content provider 322 provides primary content such as movies, video games, and television shows. The primary content may be provided directly to entertainment devices 310-316 or indirectly through entertainment service 330.

Secondary content provider 324 provides content that compliments the primary content. Secondary content may be a director's cut, information about a character, game help information, and other content that compliments the primary content. The same entity may generate both primary content and secondary content. For example, a television show may be generated by a director that also generates additional secondary content to compliment the television show. The secondary content and primary content may be purchased separately and could be displayed on different devices. For example, the primary content could be displayed through a television while the secondary content is viewed on a companion device, such as a tablet. The advertiser 320, content provider 322, and secondary content provider 324 may stream content directly to entertainment devices 310-316 or seek to have their content distributed by a service, such as entertainment service 330.

Entertainment service 330 provides content and advertisements to entertainment devices. The entertainment service 330 is shown as a single block. In reality, the functions should be widely distributed across multiple devices. In embodiments of the present invention, the various features of entertainment service 330 described herein may be provided by multiple entities and components. The entertainment service 330 comprises a game execution environment 332, a game data store 334, a content data store 336, a distribution component 338, a streaming component 340, a content recognition database 342, an ad data store 344, an ad placement component 346, and ad sales component 348, an audience data store 350, an audience processing component 352, and an audience distribution component 354. As can be seen, the various components may work together to provide content, including games, advertisements, and media titles to a client, and capture audience data. The audience data may be used to specifically target advertisements and/or content to a person. The audience data may also be aggregated and shared with or sold to others.

The game execution environment 332 provides an online gaming experience to a client device. The game execution environment 332 comprises the gaming resources required to execute a game. The game execution environment 332 comprises active memory along with computing and video processing. The game execution environment 332 receives gaming controls, such as controller input, through an I/O channel and causes the game to be manipulated and progressed according to its programming. In one embodiment, the game execution environment 332 outputs a rendered video stream that is communicated to the game device. Game progress may be saved online and associated with an individual person that has an ID through a gaming service. The game ID may be associated with a facial pattern.

The game data store 334 stores game code for various game titles. The game execution environment 332 may retrieve a game title and execute it to provide a gaming experience. Alternatively, the content distribution component 338 may download a game title to an entertainment device, such as entertainment device A 310.

The content data store 336 stores media titles, such as songs, videos, television shows, and other content. The distribution component 338 may communicate this content from content data store 336 to the entertainment devices 310-316. Once downloaded, an entertainment device may play the content on or output the content from the entertainment device. Alternatively, the streaming component 340 may use content from content data store 336 to stream the content to the person.

The content recognition database 342 includes a collection of audio clips associated with known media titles that may be compared to audio input received at the entertainment service 330. As described above, the received audio input (e.g., received from the game console 210 of FIG. 2) is mapped to the library of known media titles. Upon mapping the audio input to a known media title, the source of the audio input (i.e., the identity of media content) may be determined. The identified media title/content is then communicated back to the entertainment device (e.g., the game console) for further processing. Exemplary processing may include associating the identified media content with a person that viewed or is actively viewing the media content and storing the association as a viewing record.

The entertainment service 330 also provides advertisements. Advertisements available for distribution may be stored within ad data store 344. The advertisements may be presented as an overlay in conjunction with primary content. As well, the advertisements may be partial or full-screen advertisements that are presented between segments of a media presentation or between the beginning and end of a media presentation, such as a television commercial. The advertisements may be associated with audio content. Additionally, the advertisements may take the form of secondary content that is displayed on a companion device in conjunction with a display of primary content. Advertisements may also include instances of product placement, such as referencing an advertiser's product or service within primary content. The advertisements may also be presented when a person associated with a targeted persona is located in the audience area and/or is logged in to the entertainment service 330, as further described below.

The ad placement component 346 determines when an advertisement should be displayed to a person and/or what advertisement should be displayed. The ad placement component 346 may consume real-time audience data and automatically place an advertisement associated with a highest-bidding advertiser in front of one or more persons because the audience data indicates that the advertiser's bidding criteria is satisfied. For example, an advertiser may wish to display an advertisement to men present in Kansas City, Mo. When the audience data indicates that one or more men in Kansas City are viewing primary content, an ad could be served with that primary content to each of the men on their respective entertainment devices. The ad may be inserted into streaming content or downloaded to the various entertainment devices along with triggering mechanisms or instructions on when the advertisement should be displayed to the person. The triggering mechanisms may specify desired audience data that triggers display of the ad.

The ad sales component 348 interacts with advertisers 320 to set a price for displaying an advertisement. In one embodiment, an auction is conducted for various advertising space. The auction may be a real-time auction in which the highest bidder is selected when a viewer or viewing opportunity satisfies the advertiser's criteria. In other words, as audience data is collected and processed, advertisers may bid in real-time (i.e., as the audience is actively viewing content) to display their ads to audience members.

The audience data store 350 aggregates and stores viewing data received from entertainment devices 310-316. The viewing data may comprise aggregated viewing records for identified types of media content. Thus, the audience data store 350 aggregates the viewing data for each identified type of media content received from the entertainment devices 310-316. The audience data store 350 may additionally summarize the aggregated viewing data according to a plurality of categories. Exemplary categories include a total number of persons that watched the content, the average number of persons that watched the content per household, a number of times certain persons watched the content, determined response of people toward the content, a level of engagement of people in the media title, a length of time individuals watched the content, common distractions that were ignored or engaged in while the content was being displayed, and the like. The viewing data may similarly be summarized according to types of persons that watched the known media content. For example, personal characteristics of the persons, demographic information associated with the persons, and the like may be summarized within the viewing data.

The audience processing component 352 may build and assign personas using the audience data and a machine-learning algorithm. A persona is an abstraction of a person or groups of people that describes preferences or characteristics about the person or groups of people. The personas may be based on media content the persons have viewed or listened to, as well as other personal information stored in a user profile on the entertainment device (e.g., game console) and associated with the person. For example, the persona could define a person as a female between the ages of 20 and 35 having an interest in science fiction, movies, and sports. Similarly, a person that always has a positive emotional response to car commercials may be assigned a persona of “car enthusiast.” More than one persona may be assigned to an individual or group of individuals. For example, a family of five may have a group persona of “animated film enthusiasts” and “football enthusiasts.” Within the family, a child may be assigned a persona of “likes video games,” while the child's mother may be assigned a person of “dislikes video games.” It will be understood that the examples provided herein are merely exemplary. Any number or type of personas may be assigned to a person.

The audience distribution component 354 may distribute audience data and viewing data to content providers, advertisers, or other interested parties. For example, the audience distribution component 354 could provide information indicating that 300,000 discrete individuals viewed a television show in a geographic region. In addition to the number of people that viewed the media content, more granular information could be provided. For example, the total persons giving full attention to the content could be provided. In addition, response data for people could be provided. As well, to protect the identity of individual persons, only a persona assigned to a person may be exposed and distributed to advertisers. A value may be placed on the distribution, as a condition on its delivery, as described above. The value may also be based on the amount, type, and dearth of viewing data delivered to an advertiser or content publisher.

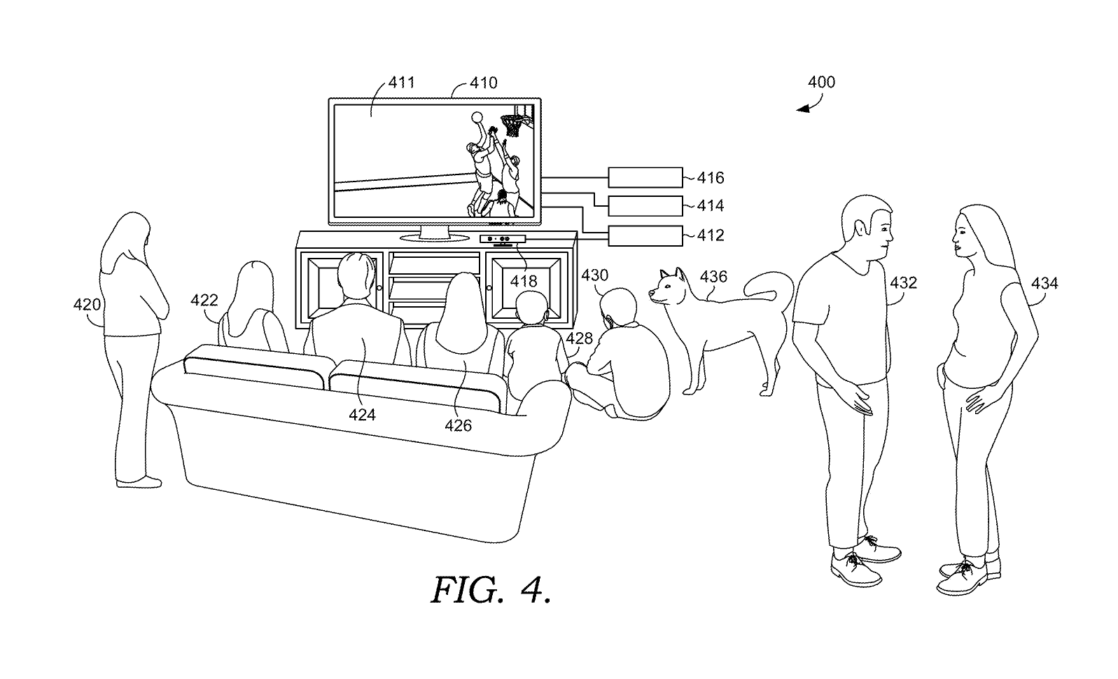

Turning now to FIG. 4, audience area 400 that illustrates audience member presence is shown, in accordance with an embodiment of the present invention. The audience area 400 is the area in front of the display device 410. In one embodiment, the audience area 400 comprises the area from which a person can see the content. In another embodiment, the audience area 400 comprises the area within a viewing range of the imaging device 418. In most embodiments, however, the viewing range of the imaging device 418 overlaps with the area from which a person can see content on the display device 410. If the content is only audio content, then the audience area 400 is the area where the person may hear the content.

Content is provided to the audience area 400 by an entertainment system that comprises a display device 410, an entertainment device 412, a cable box 414, a DVD player 416, and an imaging device 418. The entertainment device 412 may be similar to game console 210 of FIG. 2 described previously. The cable box 414 and the DVD player 416 may stream content from an entertainment service, such as entertainment service 330 of FIG. 3, to the display device 410 (e.g., television). The entertainment device 412, cable box 414, and the DVD player 416 are all coupled to the display device 410. These devices may communicate content to the display device 410 via a wired or wireless connection, and the display device 410 may display the content. In some embodiments, the content shown on the display device 410 may be selected by one or more persons within the audience. For example, a person in the audience may select content by inserting a DVD into the DVD player 416 or select content by clicking, tapping, gesturing, or pushing a button on a companion device (e.g., a tablet) or a remote in communication with the display device 410. Content selected for viewing may be tracked and stored on the entertainment device 412.

The imaging device 418 is connected to the entertainment device 412. The imaging device 418 may be similar to imaging device 213 of FIG. 2 described previously. The imaging device 418 captures image data of the audience area 400. Other devices that include imaging technology, such as the tablet 212 of FIG. 2, may also capture image data and communicate the image data to the entertainment device 412 via a wireless or wired connection. In FIGS. 4-6, the game console analyzes image data to generate audience data. However, embodiments are not limited to performance by a game console. Other entertainment devices could process imaging data to generate audience data. For example, a television, cable box, stereo receiver, or other entertainment device could analyze imaging data to generate audience data, viewing records, viewing data and other derivates of the image data describing the audience.

In one embodiment, viewing records may be gathered through image processing. A viewing record may include one or more items of information related to persons within the audience area 400 and associated with an identified type of medic content. A viewing record may include a detected number of persons within the audience area 400. Persons may be detected based on their form, appendages, height, facial features, movement, speed of movement, associations with other persons, biometric indicators, and the like. Once detected, the persons may be counted and tracked so as to prevent double counting. The number of persons within the audience area 400 also may be automatically updated as people leave and enter the audience area 400.

Viewing records may similarly indicate a direction each audience member is facing. Determining the direction persons are facing may, in some embodiments, be based on whether certain facial or body features are moving or detectable. For example, when certain features, such as a person's cheeks, chin, mouth and hairline are detected, it may indicate that a person is facing the display device 410. Viewing records may include a number of persons that are looking toward the display device 410, periodically glancing at the display device 410, or not looking at all toward the display device 410. In some embodiments, a period of time each person views identified media content may also comprise a viewing record.

As an example, a viewing record may indicate that individual 420 is standing in the background of the audience area 400 while looking at the display device 410. Individuals 422, 424, 426, and child 428 and child 430 may also be detected and determined to be all facing the display device 410. A man 432 and a woman 434 may be detected and determined to be looking away from the television. The dog 436 may also be detected, but characteristics (e.g., short stature, four legs, and long snout) about the dog 436 may not be stored as a viewing record for the content because they indicate that the dog 436 is not a person.

Additionally, a viewing record may also include an identity of each person within the audience area 400. Facial recognition technologies may be utilized to identify a person within the audience area 400 or to create and store a new identity for a person. Additional characteristics of the person (e.g., form, height, weight, etc.) may similarly be analyzed to identify a person. In one embodiment, the person's determined characteristics may be compared to characteristics of a person stored in a user profile on the entertainment device 412. If the determined characteristics match those in a stored user profile, the person may be identified as a person associated with the user profile.

Viewing records may include personal information associated with each person in the audience area 400. Exemplary personal characteristics include an estimated age, a race, a nationality, a gender, a height, a weight, a disability, a medical condition, a likely activity level of (e.g., active or relatively inactive), a role within a family (e.g., father or daughter), and the like. For example, based on the image data, an image processor within the game console 412 may determine that individual 420 is a woman of average weight. Similarly, analyzing the width, height, bone structure, and size of individual 432 may lead to a determination that the individual 432 is a male. Personal information may also be derived from stored user profile information. Such personal information may include an address, a name, an age, a birth date, an income, one or more viewing preferences (e.g., movies, games, and reality television shows) of or login credentials for each person. In this way, a viewing record may generated based on both processed image data and stored person profile data. For example, if individual 434 is identified and associated with a person profile of a 13 year old, processed image data that classifies individual 434 as an adult (i.e., over 18 years old) may be disregarded as inaccurate.

The viewing record necessarily includes an identification of the primary content being displayed when image data is captured at the imaging device 418. The primary content may, in one embodiment, be identified because it is fed through the entertainment device 412. In other embodiments, and as described above, audio output associated with the display device 410 may be received at a microphone associated with the entertainment device 412. The audio output is then compared to a library of known content and determined to correspond to a known media title or a known genre of media title (e.g., sports, music, movies, and the like). As well, other cues (e.g., whether the person appears to be listening to as opposed to watching a media presentation) may be analyzed to identify the media content (e.g., a song as opposed to the soundtrack to a movie). Thus, viewing record may be associated with the basketball game 411 that was being displayed to individuals 420, 422, 424, 426, 428, 430, 432, and 434 when images of the individuals were captured. The viewing record may also include a mapping of the image data to the exact segment of the media presentation (e.g., basketball game 411) being displayed when the image data was captured.

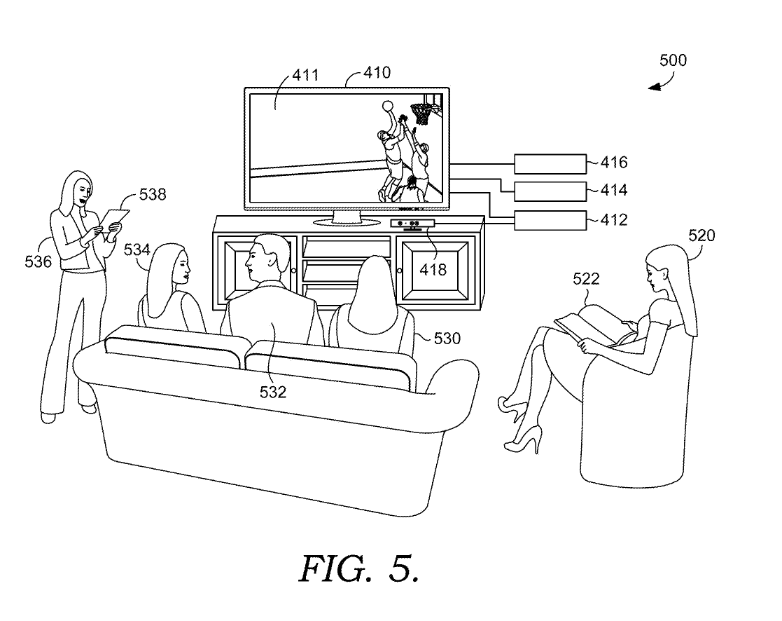

Turning now to FIG. 5, an audience area 500 depicting engagement levels of audience members is shown, in accordance with an embodiment of the present invention. The entertainment system is identical to that shown in FIG. 4, but the audience members have changed. Image data captured at the imaging device may be processed similar to how it was processed with reference to FIG. 4. However, in this illustrative embodiment, the image data may be processed to generate a viewing record that indicates a level of engagement of and/or attention paid by the audience toward the identified media content (e.g., the basketball game 411).

An indication of the level of engagement of a person may be generated based on detected traits of or actions taken by the person, such as facial features, body positioning, and body movement of the person. For example, the movement of a person's eyes, the direction the person's body is facing, the direction the person's face is turned, whether the person is engaged in another task (e.g., talking on the phone), whether the person is talking, the number of additional persons within the audience area 500, and the movement of the person (e.g., pacing, standing still, sitting, or lying down) are traits of and/or actions taken by a person that may be distilled from the image data. The determined traits may then be mapped to predetermined categories or levels of engagement (e.g., a high level of engagement or a low level of engagement). Any number of categories or levels of engagement may be created, and the examples provided herein are merely exemplary.

In another embodiment, a level of engagement may additionally be associated with one or more predetermined categories of distractions. In this way, traits of or actions taken by a person may be mapped to both a level of engagement and a type of distraction. Exemplary actions that indicate a distraction include engaging in conversation, using multiple display devices (e.g., the display device 410 and a companion device), reading a book, playing a board game, falling asleep, getting a snack, leaving the audience area 500, walking around, and the like. Exemplary distraction categories may include “interacted with other persons,” “interacted with an animal,” “interacted with other display devices,” “took a brief break,” and the like.

Other input that may be used to determine a person's level of engagement is audio data. Microphones associated with the entertainment device may pick up conversations or sounds from the audience. The audio data may be interpreted and determined to be responsive to (i.e., related to or directed at) the identified media content or nonresponsive to the media content. The audio data may be associated with a specific person (e.g., a person's voice). As well, signal data from companion devices may be collected to generate viewing record. The signal data may indicate, in greater detail than the image data, a type or identity of a distraction, as described below.

Thus, the image data gathered through imaging device may be processed to determine that individual 520 is reading a paper 522 and is therefore distracted from the content shown on display device 410. Individual 536 is viewing their tablet 538 while the content is being displayed through display device 410. In addition to observing the person holding the tablet, signal data may be analyzed to understand what the person is doing on the tablet. For example, the person could be surfing the Web, checking e-mail, checking a social network site, or performing some other task. However, the individual 536 could also be viewing secondary content that is related to the primary content shown on display device 410. What the person is doing on tablet 538 may cause a different level of engagement to be associated with the person. For example, if the activity is totally unrelated (e.g., the activity is not secondary content), then the level of engagement mapped to the person's action (e.g., looking at the tablet) and associated with the person may be determined to be quite low. On the other hand, if the person is viewing secondary content that compliments the primary content, then the individual 536's action of looking at the tablet 538 may be mapped to somewhat higher levels of engagement.

Individuals 532 and 534 are carrying on a conversation with each other but are not otherwise distracted because they are seated in front of the display device 410. If, however, audio input from individuals 532 and 534 indicate that they are speaking with each other while seated in front of the display device 410, their actions may be mapped to an intermediate level of engagement. Only individual 530 is viewing the primary content and not otherwise distracted. Accordingly, a high level of engagement may be associated with individual 530 and/or the media content being displayed.

Determined distractions and levels of engagement of a person may additionally be associated with particular portions of image data, and thus, corresponding portions of media content. As mentioned elsewhere, such information may be stored locally as a viewing record on the entertainment device or communicated to a server for remote storage and distribution. As well, the viewing record may be stored in a user profile associated with the person for whom a level of engagement or distractions was determined.

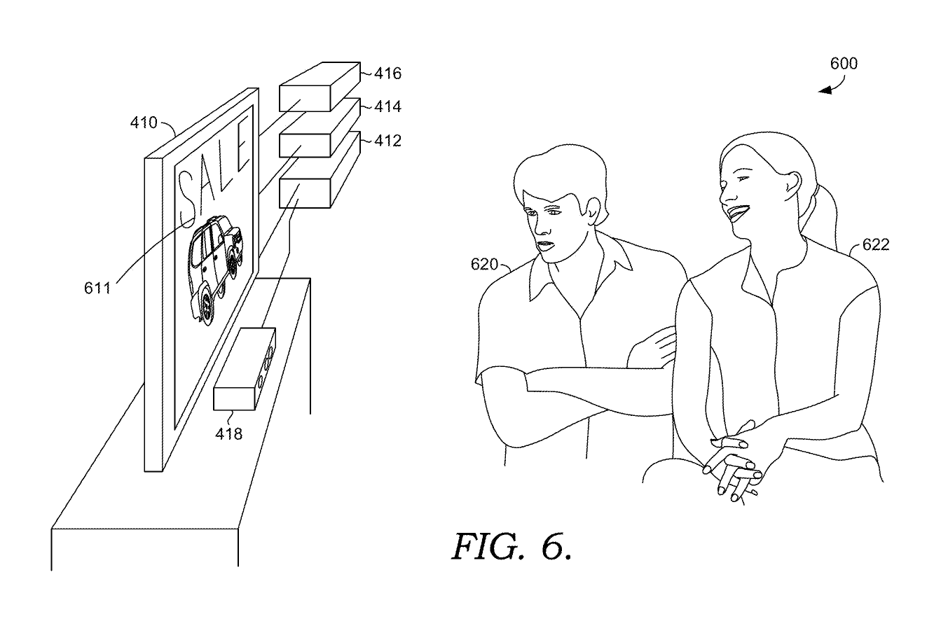

Turning now to FIG. 6, an exemplary audience area 600 that illustrates audience member response to media content is shown, in accordance with an embodiment of the present invention. The entertainment setup shown in FIG. 6 is the same as that shown in FIG. 4. However, the primary content is different. In this case, the primary content is a car commercial indicating a sale. In addition to detecting that individuals 620 and 622 are viewing the content and are paying full attention to the content, the persons' responses to the car commercial may be measured through one or more methods and stored as audience data.

In one embodiment, a person's response may be gleaned from the images and/or audio originating from the person (e.g., the person's voice). Exemplary responses include smiling, frowning, wide eyes, glaring, yelling, speaking softly, laughing, crying, and the like. Other responses may include a change to a biometric reading, such as an increased or a decreased heart rate, facial flushing, or pupil dilation. Still other responses may include movement, or a lack thereof, such as, for example, pacing, tapping, standing, sitting, darting one's eyes, fixing one's eyes, and the like. Each response may be mapped to one or more predetermined emotions, such as, for example, happiness, sadness, excitement, boredom, depression, calmness, fear, anger, confusion, disgust, and the like. For example, when a person frowns, her frown may be mapped to an emotion of dissatisfaction or displeasure. In embodiments, mapping a person's response to an emotion may additionally be based on the length of time the person held the response or the pronouncement of the person's response. As well, a person's response may be mapped to more than one emotion. For example, a person's response (e.g., smiling and jumping up and down) may indicate that the person is both happy and excited. Additionally, the predetermined categories of emotions may include tiers or spectrums of emotions. Baseline emotions of a person may also be taken into account when mapping a person's response to an emotion. For example, if the person rarely shows detectable emotions, a detected “happy” emotion for the person may be elevated to a higher “tier” of happiness, such as “elation.” As well, the baseline may serve to inform determinations about the attentiveness of the person toward a particular media title.

In some embodiments, only responses and determined emotions that are responsive to the media content being displayed to the person are associated with the media content. Responsiveness may be related to a determined level of engagement of a person, as described above. Thus, responsiveness may be determined based on the direction the person is looking when a title is being displayed. For example, a person that is turned away from the display device 410 is unlikely to be reacting to content being displayed on the display device 410. Responsiveness may similarly be determined based on the number and type of distractions located within the viewing area of the display device 410. Similarly, responsiveness may be based on an extent to which a person is interacting with or responding to distractions. For example, a person who is talking on the phone, even though facing and looking at a display screen of the display device, may be experiencing an emotion unrelated to the media content being displayed on the screen. As well, responsiveness may be determined based on whether a person is actively or has recently changed a media title that is being displayed (i.e., a person is more likely to be viewing content he or she just selected to view). It will be understood that responsiveness can be determined in any number of ways by utilizing machine-learning algorithms, and the examples provided herein are meant only to be illustrative.

Thus, returning to FIG. 6, the image data may be utilized to determine responses of individual 622 and individual 620 to the primary content. Individual 622 may be determined to have multiple responses to the car commercial, each of which may be mapped to the same or multiple emotions. For example, the individual 622 may be determined to be smiling, laughing, to be blinking normally, to be sitting, and the like. All of these reactions, alone and/or in combination, may lead to a determination that the individual 622 is pleased and happy. This is assumed to be a reaction to the primary content and recorded as a viewing record in association with the display event. By contrast, individual 620 is not smiling, has lowered eyebrows, and is crossing his arms, indicating that the individual 620 may be angry or not pleased with the car commercial.

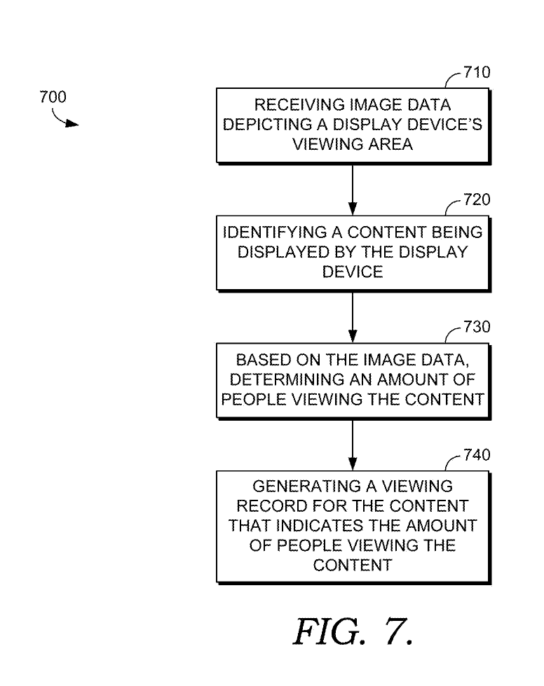

Turning now to FIG. 7, a method 700 of determining a number of users that have viewed a type of media content is described, in accordance with an embodiment of the present invention. At a step 710, image data depicting a display device's audience area is received. The image data may be received from an imaging device, such as a depth camera that is associated with an entertainment device (e.g., entertainment device A 310 of FIG. 3) and located near to a display device. The display device may be a television or other device that displays media content. The audience area is an area proximate to the display device where the person can see displayed content or hear displayed audio content.

At a step 720, media content being displayed by the display device when the image data is received is identified. The media content may be identified because it is being executed on the entertainment device. The media content may also be identified using automatic content recognition, as described above. In this way, audio output from the display device will be compared to a database of known media content, mapped to information that identifies the content, and the identifying information will be transmitted to the entertainment device. Identifying media content may include identifying a title of the media content (e.g., the name of a movie), identifying a provider, director, producer or publisher of the content, identifying a genre to which the content belongs (e.g., sports, movies, games, etc.), and the like.

At a step 730, an amount of people viewing the content is determined. The amount of people may be determined by first detecting people within the audience area. Persons may be detected based on their form, appendages, height, facial features, movement, speed of movement, associations with other persons, biometric indicators, and the like. Once detected, the persons may be counted and tracked to prevent double counting, as described above. The number of persons within the audience area of the display device also may be automatically updated as people leave and enter the audience area.

Although not shown, characteristics associated with each detected person may also be determined. The characteristics may be determined based on processing the image data. Such processing may lead to a determination of, for example, the person's gender, age, physical traits or disabilities, identity (based on facial recognition processing), facial features, weight, height, and the like. Baseline characteristics for individual viewers may additionally be determined. Such baseline characteristics may be used to determine a viewer's emotion or interests.

Also not shown, the image data may be utilized to determine a response of the person toward the media content. The response may be determined based on a change to a facial expression, a change in a biometric reading of the first person, a movement of the person, a change to the direction the person is facing, and the like. For example, the image data may indicate that a person is frowning, smiling, laughing, glaring, yelling, and/or falling asleep. Similarly, a response may include the person getting up and walking out of the audience area. Any such responses and countless other responses are capable of being distilled from the image data. Upon determining a response, the response may be mapped to an emotion, such as “happy” or “sad.”

At a step 740, a viewing record may be created that indicates the number of people viewing the media content. The viewing record may be associated with only a portion of the media content to which it corresponds. In this way, multiple viewing records may be generated for the different segments of identified content. As well, a viewing record for the media content can include other information, such as a person's response to the media content, the characteristics of the person viewing the media content, the person's determined emotions while viewing the media content, and the like. Every viewing record for identified content may be aggregated, generating viewing data for the identified content. Although not shown, the viewing data for the media content can be communicated to an entertainment service, such as entertainment service 330 of FIG. 3. As well, the viewing records and/or viewing data may be stored locally on an entertainment device, such as entertainment device A 310 of FIG. 3.

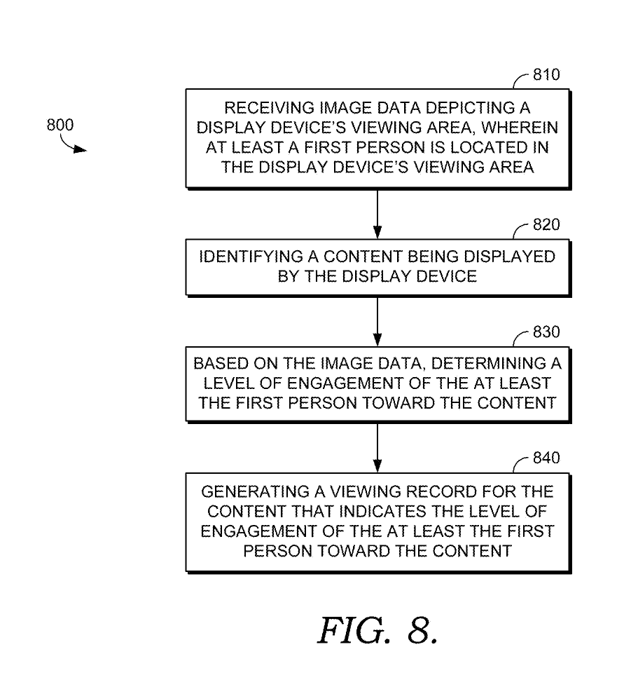

Turning now to FIG. 8, a method 800 of determining a level of engagement of a user toward media content is described, in accordance with an embodiment of the present invention. At a step 810, image data depicting a display device's viewing area is received. The image data may include still images, streaming video content and/or a combination of the two. The image data may be received automatically and in real-time. As described above, the image data may be received at an entertainment device, such as the entertainment device A 310 of FIG. 3, from an imaging device, such as a Web camera. The image data may depict the audience area where a person is located and that is proximate to a display device. The display device displays the content, such as a movie or game.

At a step 820, a determination is made about the type of media title being displayed to the person in a manner similar or the same as that described above in step 720 of FIG. 7.

At a step 830, the image data is analyzed to determine a response of the person toward the media content. The response may be determined from a change to a facial expression, a change in a biometric reading of the first person, a movement of the person, a change in the direction the person is facing, and the like. For example, the image data may indicate that the person frowning, smiling, laughing, glaring, yelling, and/or falling asleep. Similarly, a response might include the person getting up and walking out of the audience area. Any such responses and countless other responses are capable of being distilled from the image data.

The response may further be mapped to a level of engagement of the person. The level of engagement may indicate the person's interest in the content. In one embodiment, the level of engagement may be based on the movement of a person's eyes. For example, if a person's eyes are darting or turned away from a display screen, the person may be determined to not be very engaged in the displayed media content. Although not depicted, determining the level of engagement of persons toward media content may also include determining the level of engagement of the persons toward particular segments or portions of the media content.

Finally, at a step 840, a viewing record for the identified content that indicates at least one person's level of engagement toward the identified content, or toward specific known portions of the identified content, is stored. Viewing records for the content may be aggregated and stored as viewing data for the content.

Although not shown in FIGS. 7-8, additional steps of both methods may be possible. In particular, based on, for example, the level of engagement of a person toward the content, an emotion of a person toward the content, or a characteristic of a person in the audience area (e.g., a young age), it may be determined that content being displayed should be altered or paused. A decision to replace content may also be based on the subject matter associated with the media content, such as, for example, a rating associated with the media content or stored controls (e.g., parental) specifying types of persons who may view the content. Similarly, content may be paused or replaced when audience members are distracted and resumed when audience members are engaged in the content.

As an example used for illustrative purposes only, two adult persons may be viewing a rated-R movie when a ten-year-old child enters the audience of the display device. Upon detecting the child, and determining a likely age of the child, the movie may be paused, preventing the child from viewing the movie and/or alerting the adults to the presence of the child.

In one aspect, alternate endings or alternate portions of media titles may be presented to persons based on their characteristics, their viewing histories, their geographic information, or based on historical responses of a person to certain types of content (e.g., jokes). For example, an advertiser may want to have a person view a series of six, ordered advertisements to engage the person in the advertisement. Thus, upon identifying the person and determining, based on stored viewing records, the advertisements the person has already viewed (e.g., advertisements one through three), the system can determine the next advertisement in the series to display (e.g., advertisement four). In some embodiments, selecting replacement media content may be based on querying a stored user profile to determine the person's viewing history and stored preferences for certain types of content.

In some embodiments, content may be adjusted automatically or based on input from audience members. Default settings or user-specified instructions may be utilized to determine types of content that can be automatically adjusted. For example, user input may be received specifying that secondary content (e.g., television commercials) should be automatically skipped. In this way, the entertainment device would first determine whether primary or secondary content is being displayed to the audience. Subsequently, the entertainment device would utilize the default or user-specified rules to determine that, based on the classification of the content, the content should or should not be automatically adjusted. In other embodiments, default settings and/or user-specified instructions may be utilized to determine that content can be adjusted only when audience approval is received. In this case, the entertainment device may distribute for presentation on the display device a message or option that allows the audience to select whether the content should be adjusted (e.g., replaced or paused). The user may then select to adjust the content using, for example, a remote control.

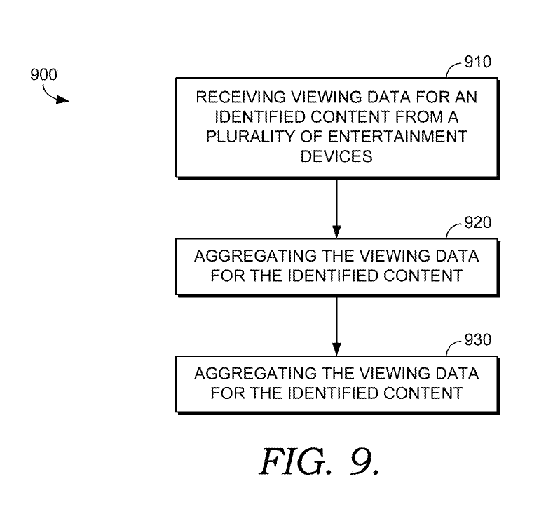

Turning to FIG. 9, a method 900 for communicating viewing data generated at an entertainment device to a content provider is described, in accordance with an embodiment of the present invention. At a step 910, a server receives viewing data for an identified type of media content from a plurality of entertainment devices. The viewing data may include aggregated viewing records for the identified media content. Each viewing record may include a discrete item or multiple items of information related to an event, response to, or characteristic of a person having viewed the content. The viewing record may similarly be associated with a person located proximate to the display device regardless of whether the person viewed content on the display device. The viewing data may include, for example, persons' responses to the content, a level of engagement of persons in the content, a number of persons that have viewed the content, a number of times the content has been viewed, and by which persons, the segments of the content that received the most favorable responses from people, and the like.

At a step 920, the viewing data from each entertainment device is aggregated by the server. Viewing data may be aggregated according to identified titles of content (e.g., a specific video game or a specific television show). Similarly, viewing data may be aggregated according to other categories, such as types of content (e.g., movie or game or advertisement), genres of content (e.g., comedy, drama, animated), and the like. As well, the server may summarize viewing data across a variety of categories, including, for example, types of viewers, viewer characteristics, levels of engagement of viewers, and viewer emotions.

At a step 930, the viewing data may be communicated to content providers. As a condition of communicating the viewing data to content providers, a value for the viewing data may be determined and agreed to be paid by the content providers. As well, in some embodiments, an auction may be held and a highest bidder may receive the viewing data. A value may also be determined for restricting viewing data to only certain content providers. For example, if an advertiser wants viewing data associated with its advertisement to remain private, the advertiser may pay to restrict distribution of that viewing data.

Although not shown, targeted content may be received from content providers at the server. The targeted content may be targeted to particular persons, geographic regions, user demographics, entertainment devices, and the like. The targeted content may be associated with advertiser-specific distribution protocols or criteria (e.g., criteria requiring that a certain number of people must be viewing content on a display device before the advertiser's content is displayed). Upon receiving the targeted content, the server can distribute such content to the entertainment devices. Server distribution similarly may be based on protocols specified by the content providers, amount of available space to advertiser, and additional determinations made by the server.

Embodiments of the invention have been described to be illustrative rather than restrictive. It will be understood that certain features and subcombinations are of utility and may be employed without reference to other features and subcombinations. This is contemplated by and is within the scope of the claims.

1-9. (canceled)

10. One or more computer storage media having computer-executable instructions embodied thereon that, when executed, perform a method of determining a person's level of engagement in media content, the method comprising:
receiving image data depicting a display device's audience area, wherein a first person is located in the display device's audience area;
identifying a content being displayed by the display device;
based on the image data, determining a level of engagement of the first person toward the content, wherein the level of engagement of the first person toward the content is determined based at least in part on a heart rate of the first person that is determined by analysis of the image data, and wherein the level of engagement of the first person is determined based at least in part on tracking eye movement of the first person and mapping the eye movement of the first person to a predetermined level of engagement; and
generating a first viewing record for the content that indicates the level of engagement of the at least the first person toward the content.

11. The one or more computer storage media of claim 10, wherein identifying the content being displayed further comprises utilizing automatic content recognition techniques to identify a source of audio output associated with the content.

12. (canceled)

13. The one or more computer storage media of claim 10, wherein determining the level of engagement of the at least the first person further comprises determining that a first level of engagement of the first person is responsive to a first segment of the content and determining that at least a second level of engagement of the first person is responsive to a least a second segment of the content.

14. The one or more computer storage media of claim 13, further comprising communicating viewing records for the content to an entertainment service, wherein the first viewing record indicates the level of engagement of the first person toward the first segment of the content, and wherein a second viewing record indicates the at least the second level of engagement of the first person toward the second segment of the content.

15. The one or more computer storage media of claim 10, further comprising generating viewing data for the content by aggregating viewing records for the content.

16. The one or more computer storage media of claim 15, further comprising communicating the viewing data to an entertainment service, wherein the entertainment service receives viewing data for the content from a plurality of entertainment devices.

17. The one or more computer storage media of claim 10, further comprising:
determining, based on the image data, a level of engagement of at least a second person toward the content; and
generating a third viewing record for the content that indicates the level of engagement of the second person toward the content.

18-23. (canceled)
